(19) United States
(12) Patent Application Publication
(10) Pub. No.: US 2017/0240097 A1
(43) Pub. Date: Aug. 24, 2017

(54) VEHICLE VISIBILITY INCREASING SYSTEM

(71) Applicant: Steve Perez, Staten Island, NY (US)

(72) Inventor: Steve Perez, Staten Island, NY (US)

(21) Appl. No.: 15/052,842

(22) Filed: Feb. 24, 2016

(51) Int. Cl. B60Q 1/26; B60Q 1/50; B60Q 1/46; B60Q 1/00; B60Q 1/30; B60Q 1/28

(52) U.S. Cl. CPC B60Q 1/2607; B60Q 1/302; B60Q 1/28; B60Q 1/46; B60Q 1/0076; B60Q 1/50; B60Q 1/0088; B60Q 1/2615; B60Q 1/0035

(57) ABSTRACT

A vehicle visibility increasing system includes a vehicle having a rear window and a front window. A pair of light emitters is provided. One of the light emitters is positioned adjacent to and is directed outwardly of the rear window. One of the light emitters is positioned adjacent to and is directed outwardly of the front window. A power cord is electrically coupled to each of the light emitters. A power plug is electrically coupled to the power cord. A control is in electrical communication with the power cord and is actuated to turn the light emitters or off.

### BACKGROUND OF THE DISCLOSURE

### Field of the Disclosure

The disclosure relates to vehicle lighting devices and more particularly pertains to a new vehicle lighting device for increasing visibility of a vehicle.

### SUMMARY OF THE DISCLOSURE

An embodiment of the disclosure meets the needs presented above by generally comprising a vehicle that has a rear window and a front window. A pair of light emitters is provided. One of the light emitters is positioned adjacent to and is directed outwardly of the rear window. One of the light emitters is positioned adjacent to and is directed outwardly of the front window. A power cord is electrically coupled to each of the light emitters. A power plug is electrically coupled to the power cord. A control is in electrical communication with the power cord and is actuated to turn the light emitters or off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a vehicle visibility increasing system according to an embodiment of the disclosure.

FIG. 2 is a front view of an embodiment of the disclosure.

FIG. 3 is a rear view of an embodiment of the disclosure.

FIG. 4 is a schematic view of an embodiment of the disclosure.

### DESCRIPTION OF THE PREFERRED EMBODIMENT

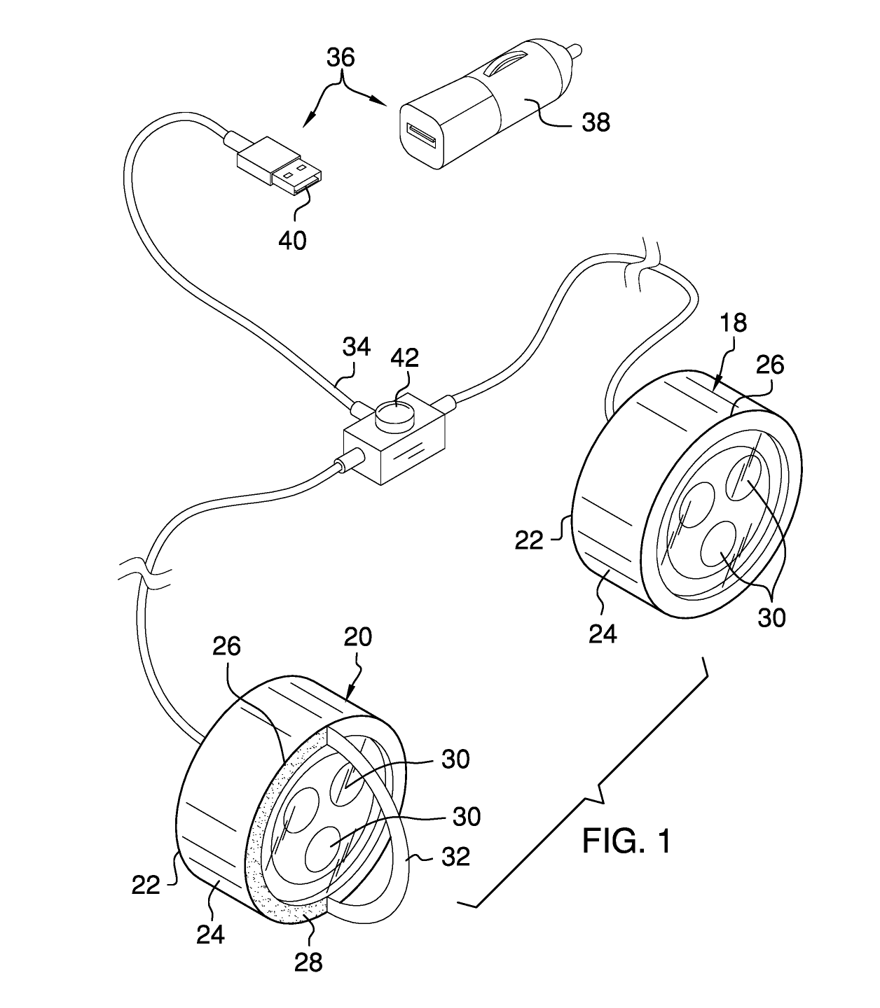

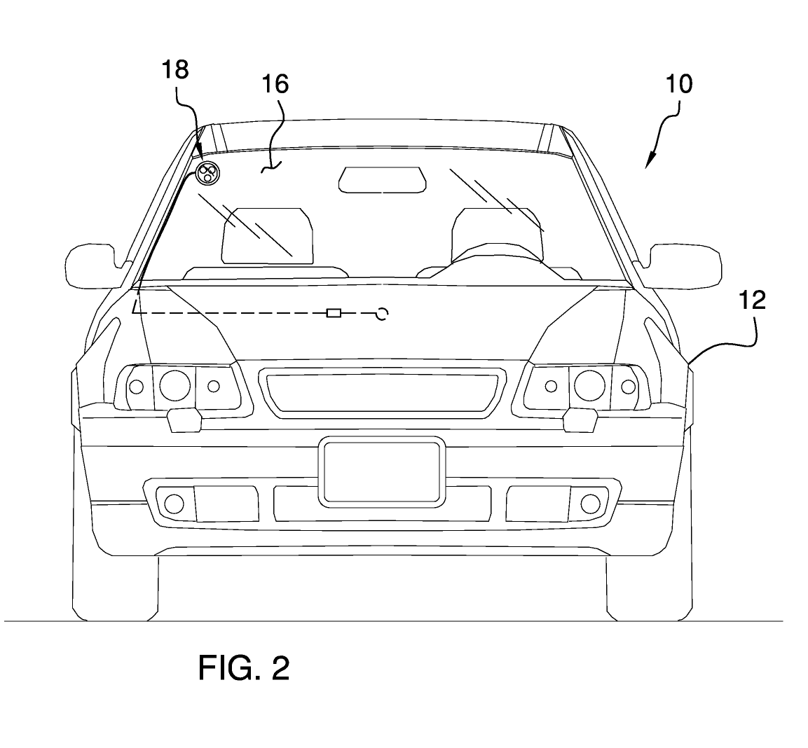

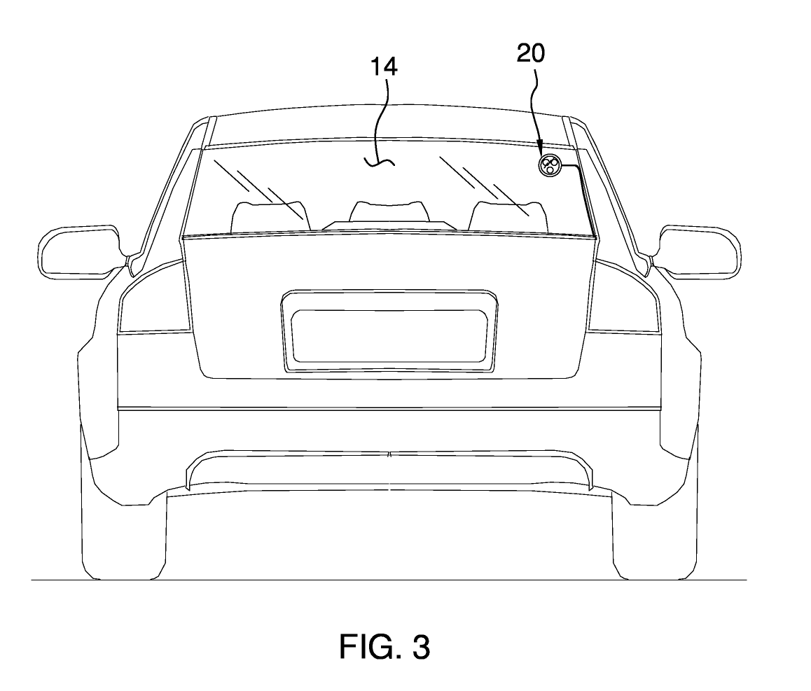

With reference now to the drawings, and in particular to FIGS. 1 through 4 thereof, a new vehicle lighting device embodying the principles and concepts of an embodiment of the disclosure and generally designated by the reference numeral 10 will be described.

As best illustrated in FIGS. 1 through 4, the vehicle visibility increasing system 10 generally comprises a vehicle 12 having a rear window 14 and a front window 16. The vehicle 12 is conventional and may generally comprise a car, SUV, minivan, or the like.

A pair of light emitters 18, 20 is provided and each is positioned within the vehicle 12. One of the light emitters 18 is positioned adjacent to the front window 16 and directed outwardly thereof and one of the light emitters 20 is positioned adjacent to the rear window 14 and directly outwardly thereof. Each of the light emitters 18, 20 comprises a housing 22 having a perimeter wall 24 with an outer edge 26 defining an opening into the housing 12. A light 30, or lights, is mounted within the housing 12 and emits light outwardly of the opening when the light 30 is turned on. The light 30 may comprise one or more light emitting diodes. The light 30 may emit red light. An adhesive 28 is positioned on the outer edge 26. The adhesive 28 secures the housing 22 to an inner surface of a selected one of the rear 14 or front 16 windows. A non-stick covering 32 may be positioned on the adhesive 28.

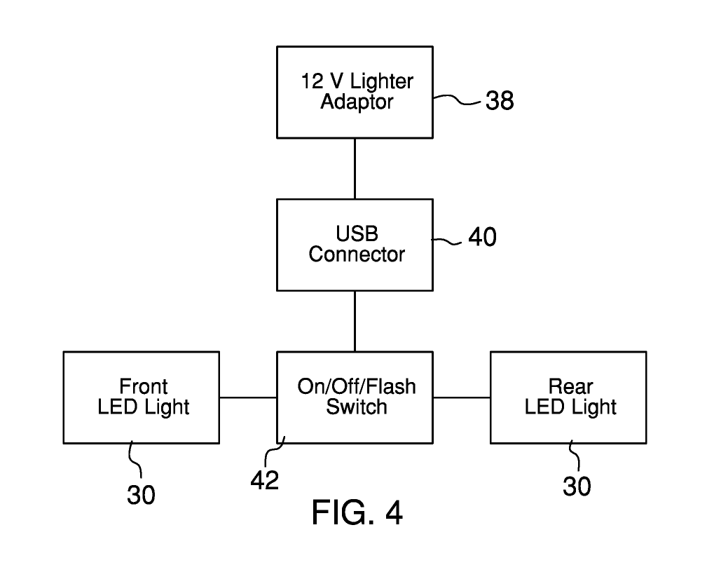

A power cord 34 is electrically coupled to each of the light emitters 18, 20 and a power plug 36 is electrically coupled to the power cord 34. The power plug 36 may comprise any conventional power plug typically used for a vehicle and may include a vehicle power port plug 38, otherwise known as a 12V lighter adapter, a USB plug 40, or a combination thereof as shown in FIG. 1. A control 42 is in electrical communication with the power cord 34. The control 42 is actuated to turn the light emitters 18, 20 or off. The control 42, comprising an on/off switch as shown in FIG. 4, may be configured so that user may select that the light emitters 18, 20 flash on and off when the light emitters 18, 20 are turned on or that the light emitters 18, 20 emit a steady light.

In use, the light emitters 18, 20 are mounted within the vehicle 12 as stated above and as shown in the Figures. The light emitters 18, 20 may be used as needed but particularly when the user wishes to increase the visibility of the vehicle 12 to other, adjacent vehicles. For example, the user may turn on the light emitters 18, 20 when small children are within the vehicle 12 such that other vehicles provide additional space for the vehicle 12 employing the light emitters 18, 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An auxiliary light system for a vehicle to increase visibility of the vehicle, said system comprising:
a vehicle having a rear window and a front window;
a pair of light emitters, one of said light emitters being positioned adjacent to and being directed outwardly of said rear window, one of said light emitters being positioned adjacent to and being directed outwardly of said front window;
a power cord being electrically coupled to each of said light emitters;
a power plug being electrically coupled to said power cord; and
a control being in electrical communication with said power cord, said control being actuated to turn said light emitters or off.

2. The auxiliary light system according to claim 1, wherein each of said light emitters comprises:
a housing having a perimeter wall having an outer edge defining an opening into said housing;
a light being mounted within said housing and emitting light outwardly of said opening when said light is turned on;
an adhesive being positioned on said outer edge, said adhesive securing said housing to an inner surface of a selected one of said rear or front windows.

3. The auxiliary light system according to claim 2, wherein said light emits red light.

4. The auxiliary light system according to claim 1, wherein said light emitters flash on and off when said light emitters are turned on.

5. An auxiliary light system for a vehicle to increase visibility of the vehicle, said system comprising:
a vehicle having a rear window and a front window;
a pair of light emitters, each of said light emitters comprising:
a housing having a perimeter wall having an outer edge defining an opening into said housing;
a light being mounted within said housing and emitting light outwardly of said opening when said light is turned on, said light emitting red light;
an adhesive being positioned on said outer edge, said adhesive securing said housing to an inner surface of a selected one of said rear or front windows;
a power cord being electrically coupled to each of said light emitters;
a power plug being electrically coupled to said power cord;
a control being in electrical communication with said power cord, said control being actuated to turn said light emitters or off, said light emitters flashing on and off when said light emitters are turned on.
